(19) United States
(12) Patent Application Publication
(10) Pub. No.: US 2019/0264775 A1
(43) Pub. Date: Aug. 29, 2019

(54) CENTRIFUGAL PENDULUM ABSORBER INCLUDING SPRINGS FIXED TO CIRCUMFERENTIAL EDGES OF MASSES

(71) Applicant: Schaeffler Technologies AG & Co. KG, Herzogenaurach (DE)

(72) Inventors: Stephan FACEMIRE, North Lawrence, OH (US); Mike SWANK, Shreve, OH (US); Thorsten KRAUSE, Buehl (DE); Benjamin VOEGTLE, Karlsruhe (DE)

(21) Appl. No.: 15/904,640

(22) Filed: Feb. 26, 2018

(51) Int. Cl. F16F 15/14; F16H 45/02

(52) U.S. Cl. CPC F16F 15/1421; F16H 2045/0263; F16H 45/02

(57) ABSTRACT

A centrifugal pendulum absorber is provided. The centrifugal pendulum absorber includes a flange, a first mass fixed circumferentially movable with respect to the flange by first rollers along a first pendulum path, a second mass fixed circumferentially movable with respect to the flange by second rollers along a second pendulum path, and a spring connecting a circumferential end of the pair of first masses to a circumferential end of the pair of second masses. The first and second pendulum paths each include a middle region and circumferential ends extending radially inward from the middle region such that the first and second masses are movable radially inward such that the spring compresses when first and second masses are at the circumferential ends of the respective first and second pendulum paths.

The present disclosure relates generally to torque converters and more specifically to centrifugal pendulum absorbers of torque converters.

### BACKGROUND

DE 102014210489 discloses providing springs circumferentially between masses of centrifugal pendulum absorber.

FIGS. 1a to 1c show a conventionally tuned centrifugal pendulum absorber (CPA) 200. FIG. 1a solely illustrates roller-receiving slots 202 in one mass 204 (FIGS. 1b, 1c), one set of roller-receiving slots 206 in flange 208 (FIGS. 1b, 1c) and one track 210 in flange 208. FIG. 1b illustrates a section of CPA 200 in which masses 204 have traveled zero degrees with respect to flange 208 and springs 214 connecting adjacent masses 204 are not compressed. FIG. 1c illustrates the same section of CPA 200 in which masses 204 have traveled twenty-eight degrees with respect to flange 208 and springs 214 connecting adjacent masses 204 are compressed by approximately 2.6 mm.

As shown in FIG. 1a, in which masses 204 have traveled zero degrees with respect to flange 208, slots 206 are radially and circumferentially larger than slots 202 and slots 202 are circumferentially centered within slots 206 such that both of the circumferential edges 202a, 202b of each slot 202 are a same circumferential distance from the respective circumferential edge 206a, 206b of the respective slot 206. Additionally, slots 202 are each radially aligned in the respective slot 206 such that outer edges 202c of each slot 202 are spaced from the outer edge 206c of the respective slot 206 and inner edges 202d of each slot 202 are spaced from the inner edge 206d of the respective slot 206.

Masses 204 are tuned such that a center 215 (FIG. 1a) of the pendulum mass 204 swings in a pendulum motion along a path 218a having a constant curvature, which may vary slightly due to manufacturing tolerances, during operation of CPA 200. In other words, center 215 swings in a pendulum motion about a center point 211, such that center 215 is a same distance 217 from center point 211 during the entire pendulum path 218a. A spacer or bolt 216 (FIGS. 1b, 1c), which fixes two elements of mass 204 on opposite axial sides of flange 208 together, follows a path 218d shown in FIG. 1a. FIG. 1a also illustrates possible paths 218b, 218c taken by centers 220a of rollers 220 (FIGS. 1b, 1c).

### SUMMARY OF THE INVENTION

A centrifugal pendulum absorber is provided. The centrifugal pendulum absorber includes a flange, a first mass fixed circumferentially movable with respect to the flange by first rollers along a first pendulum path, a second mass fixed circumferentially movable with respect to the flange by second rollers along a second pendulum path, and a spring connecting a circumferential end of the pair of first masses to a circumferential end of the pair of second masses. The first and second pendulum paths each include a middle region and circumferential ends extending radially inward from the middle region such that the first and second masses are movable radially inward such that the spring compresses when first and second masses are at the circumferential ends of the respective first and second pendulum paths.

Embodiments of the centrifugal pendulum absorber may include a first flange slot receiving the first roller and a second flange slot receiving the second roller. The first mass may include a first mass slot receiving the first roller and the second mass may include a second mass slot receiving the second roller. Each of the first mass slots and the second mass slots may have a convex shape with respect to a center axis of the centrifugal pendulum absorber and the first flange slot and the second flange slot may have a concave shape with respect to center axis. In a position of zero degrees of travel of the first and second masses with respect to the flange, the first mass slots may be aligned within the first flange slot and the second mass slots may be aligned within the second flange slot. In the position of zero degrees of travel of the first and second masses with respect to the flange, radially outer peaks of each of the first mass slots may be closer to a perimeter of the first flange slot than a radially inner peak of the respective first mass slot and radially outer peaks of each of the second mass slots may be closer to a perimeter of the second flange slot than a radially inner peak of the respective second mass slot. The middle regions of the first and second pendulum paths may each have a constant curvature. The circumferential ends of the first and second pendulum paths may each have a curvature different from the constant curvature of the middle regions. Circumferential ends of the first and second pendulum paths may each have higher tuning order than the middle regions. Circumferential ends of the first and second pendulum paths may each have at 50% higher tuning order than the middle regions. The middle regions may have a tuning order within 5% of an ideal tuning order.

A torque converter including the centrifugal pendulum absorber is also provided. The torque converter includes a damper assembly including the centrifugal pendulum absorber.

A method of forming a centrifugal pendulum absorber is also provided. The method includes circumferentially movably fixing a first mass to a flange such that the first mass is configured for traveling along a first pendulum path; circumferentially movably fixing a second mass to the flange such that the second mass is configured for traveling along a second pendulum path; and connecting a circumferential end of the first mass to a circumferential end of the second mass by a spring. The first mass and the second mass are movable radially inward such that the spring compresses when first and second masses are at circumferential ends of the respective first and second pendulum paths.

Embodiments of the method may include providing a first roller in a first flange slot of the flange and in a first mass slot in each of the first masses, and providing a second roller in a second flange slot of the flange and in a second mass slot in the second mass. Each of the first mass slots and the second mass slots may have a convex shape with respect to a center axis of the centrifugal pendulum absorber and the first flange slot and the second flange slot may have a concave shape with respect to center axis. In a position of zero degrees of travel of the first and second masses with respect to the flange, the first mass slots may be aligned within the first flange slot and the second mass slots are aligned within the second flange slot. Middle regions of the first and second pendulum paths may each have a constant curvature. The circumferential ends of the first and second pendulum paths may each have a curvature different from the constant curvature of the middle regions. Circumferential ends of the first and second pendulum paths may each have higher tuning order than the middle regions. Circumferential ends of the first and second pendulum paths may each have at 50% higher tuning order than the middle regions. The middle regions may have a tuning order within 5% of an ideal tuning order.

### BRIEF DESCRIPTION OF THE DRAWINGS

The present invention is described below by reference to the following drawings, in which:

FIGS. 1a to 1c show a conventionally tuned centrifugal pendulum absorber;

FIG. 2 shows a cross-sectional side view of a torque converter in accordance with an embodiment of the present invention;

FIGS. 3a to 3c show views of centrifugal pendulum absorber in accordance with an embodiment of the present invention;

FIG. 4 shows a plan view of a flange of the centrifugal pendulum absorber shown in FIGS. 3a to 3c; and

FIG. 5 shows a graph illustrating the tuning order of centrifugal pendulum absorber masses in accordance with an exemplary embodiment of the present disclosure.

### DETAILED DESCRIPTION

Tuning of pendulum masses of a centrifugal pendulum absorber involves designing the masses absorb vibrations in a specific frequency range—referred to as the tuning order of the pendulum masses. The tuning order of a pendulum mass can be set by designing its mass, its effective radius relative to its axis of rotation and/or its pendulum path. The present disclosure provides a centrifugal pendulum absorber (CPA) including springs between pendulum masses in order to eliminate a click noise when transitioning from drive to neutral or reverse to neutral, and CPA masses tuned to a higher order at the ends of their travel paths such that the masses are brought radially inward and closer together to increases compression of the spring achieving a same spring force with a lower spring rate to optimize the effectiveness of CPA isolation.

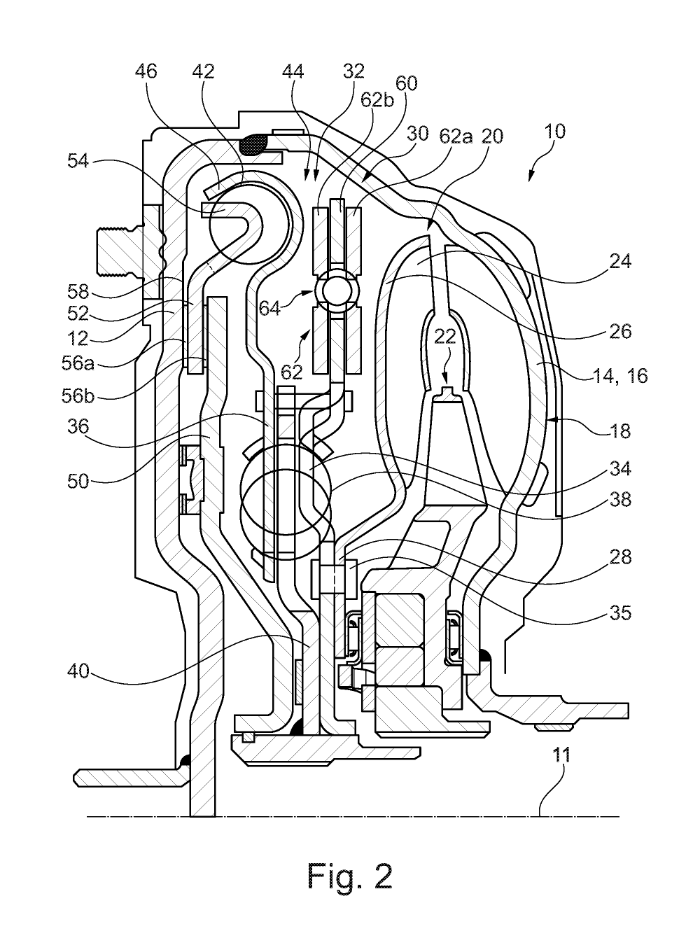

FIG. 2 shows a cross-sectional side view of a torque converter 10 in accordance with an embodiment of the present invention. Torque converter 10 is rotatable about a center axis 11 and includes a front cover 12 for connecting to a crankshaft of an internal combustion engine and a rear cover 14 forming a shell 16 of an impeller or pump 18. The terms axially, radially and circumferentially as used herein are used with respect to center axis 11. Torque converter 10 also includes a turbine 20 opposite impeller 18 and a stator 22 axially between impeller 18 and turbine 20. Turbine 20 includes a plurality of blades 24 supported on a rounded portion 26 of turbine 20 at a rear-cover side of turbine 20. Turbine 20 further includes an inner radial extension 28 protruding radially inward from rounded portion 26. On a front-cover side of turbine 20, turbine 20 is connected to a damper assembly 30.

Damper assembly 30 includes a CPA 32 in accordance with an embodiment of the present invention, which is discussed in further detail below. Damper assembly 30 further includes a first cover plate 34 that is riveted to inner radial extension 28 of turbine 20 by rivets 35 and a second cover plate 36 axially between first cover plate 34 and front cover 12, with cover plates 34, 36 supporting a plurality of circumferentially spaced radially inner set of springs 38 axially therebetween. Sandwiched axially between cover plates 34, 36, damper assembly 30 includes a drive flange 40 whose inner radial end is configured as a hub for connecting to a transmission input shaft. Drive flange 40 includes a plurality of circumferentially extending slots formed therein for receiving springs 38. Radially outside of springs 38, damper assembly 30 further includes a plurality of circumferentially spaced radially outer set of springs 42. A radially outer end 44 of second cover plate 36 forms a spring retainer 46 for receiving springs 42.

A piston 50 is provided between front cover 12 and damper assembly 30 and a clutch plate 52 is provided axially between piston 50 and front cover 12. Clutch plate 52, at a radially outer end thereof, includes a plurality of circumferentially spaced projections 54 for extending into the circumferential spaces formed between springs 42. Clutch plate 50, at a radially inner end thereof, is provided with a friction material 56a on a front cover side thereof for engaging an inner axial surface 58 of front cover 12 and a friction material 56b on a rear cover side thereof for engaging piston 50. Piston 50, clutch plate 52 and inner axial surface 58 form a lockup clutch for drivingly coupling turbine 20 to front cover 12 via damper assembly 30. Fluid pressure differences between a front cover side of piston 50 and a rear cover side of piston 50 control whether piston 50 engages or is disengaged from front cover 12. Cover plates 34, 36 transfer torque from turbine 20 to drive flange 40, which in turn drives the transmission input shaft. Cover plates 34, 36 together transfer torque to springs 42, which transfer torque to clutch plate 52.

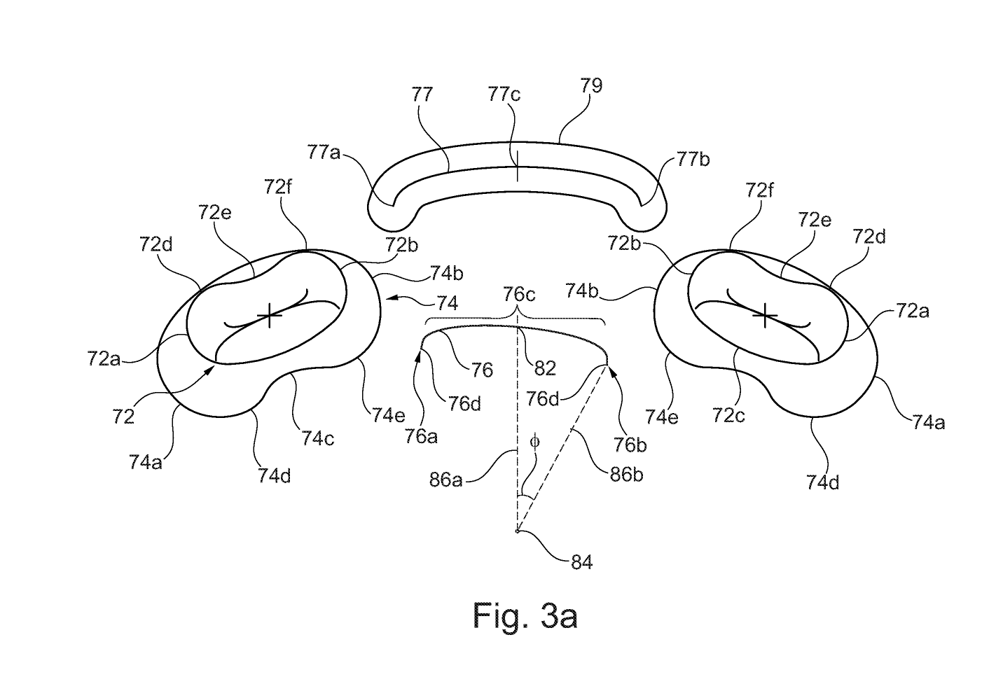

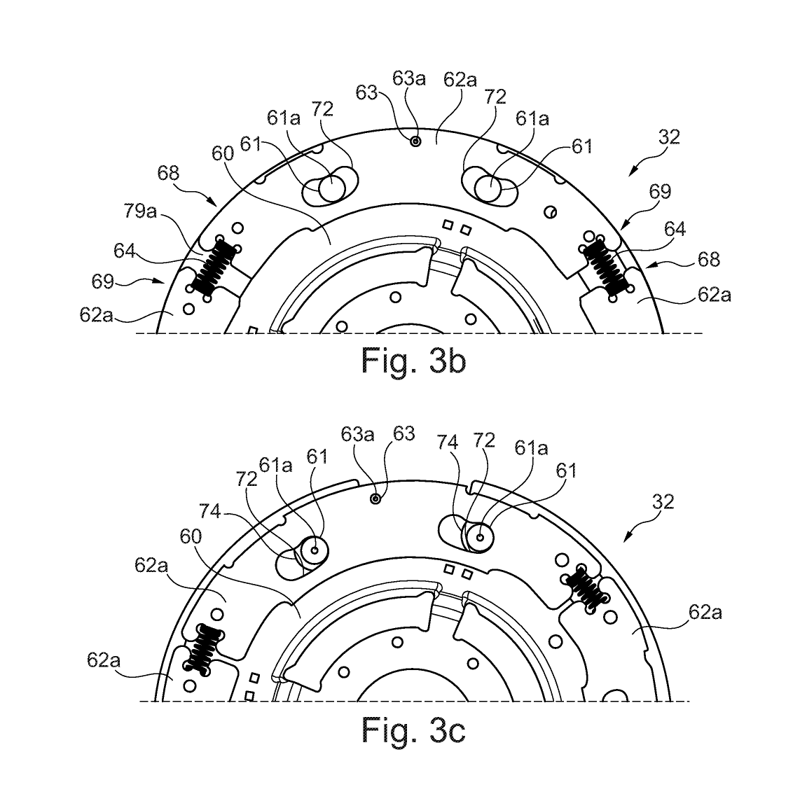

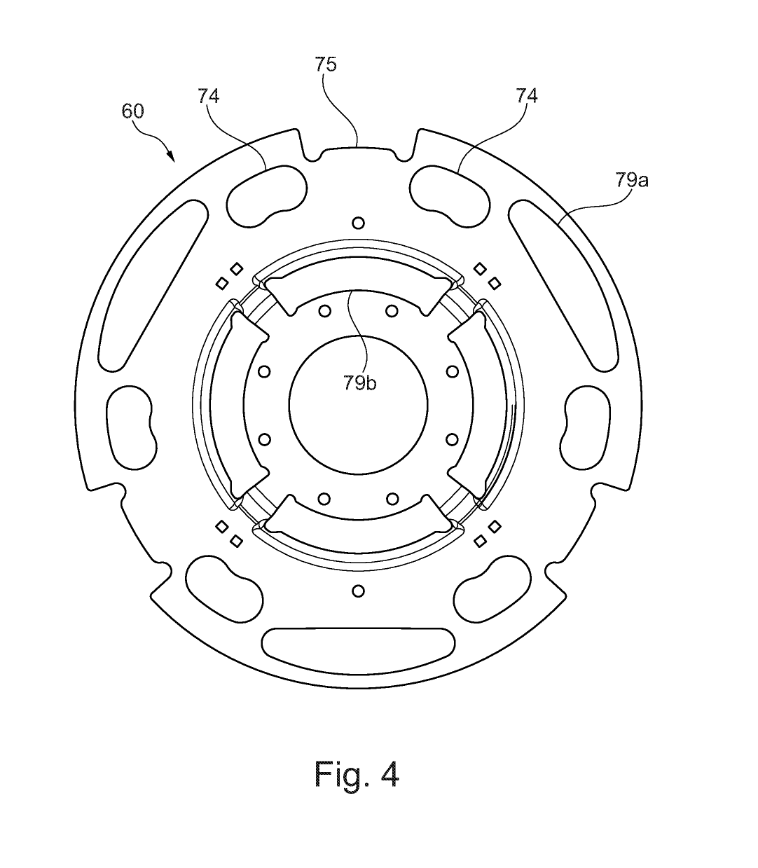

Referring back to CPA 32, it includes a flange 60, which is formed at a radially outer end of cover plate 34 and a plurality of circumferentially spaced masses 62, each formed of two mass elements—a rear side mass element 62a facing a rear cover side of torque converter 10 and a front side mass element 62b facing a front cover side of torque converter 10—on opposite axial sides of flange 60. A plan view of flange 60 is shown in FIG. 4. Each of mass elements 62a are circumferentially offset from each other and each of mass elements 62b are circumferentially offset from each other. In one preferred embodiment, CPA 32 includes four masses 62, and thus four mass elements 62a and four mass element 62b. Masses 62 are circumferentially movable with respect to flange 60 by rollers 61 (FIGS. 3b, 3c) during operation of torque converter 10. Each mass element 62a is fixed to one of mass elements 62b by a spacer or bolt 63 (FIGS. 3b, 3c), forming a plurality of pairs of mass elements 62a, 62b forming masses 62—here four pairs of mass elements 62a, 62b forming masses 62. Each mass 62 is connected to both of the circumferentially adjacent masses 62 by a respective spring 64, as is further detailed below with respect to FIGS. 3b, 3c. In other words, at a first circumferential end thereof, each mass 62 is connected to a circumferential end of a first additional mass 62 by one spring 64, and at a second circumferential end thereof, each mass 62 is connected to a circumferential end of a second additional of mass 62 by another spring 64.

FIGS. 3a to 3c show further views of CPA 32. FIG. 3a solely schematically illustrates two roller-receiving slots 72 in one mass 62 (slots 72 are formed in each of mass elements 62a, 62b), one set of two roller-receiving slots 74 in flange 60 and one track 75 in flange 60, and a travel path of a center 82 of mass 62 during operation. FIG. 3b illustrates a section of CPA 32 in which masses 62 have traveled zero degrees with respect to flange 60 and springs 64 connecting adjacent masses 62 are not compressed. FIG. 3c illustrates the same section of CPA 32 as in FIG. 3b in which masses 62 have traveled twenty-eight degrees with respect to flange 60 and springs 64 connecting adjacent masses 62 are compressed by approximately 9.3 mm. Springs 64 are received in radially outer slots 79a of flange 60, and flange 60 includes radially inner slots 79b for receiving a radially inner set of damper springs.

As shown in FIG. 3a, slots 72, 74 have a positive curvature, which means slots 72 receiving rollers 61 (FIGS. 3b, 3c) in mass elements 62a, 62b have a convex shape with respect to center axis 11 (FIG. 2) of CPA 32 and slots 74 receiving rollers 61 in flange 60 have a concave shape with respect to center axis 11. For slot 72, a radially inner middle peak edge 72c of slot 72 halfway between circumferential end edges 72a, 72b of each slot 72 is closer to center axis 11 than circumferential end edges 72a, 72b. A radially outer peak edge 72d of the perimeter between end edge 72a and a radially outer middle edge 72e, which is halfway between circumferential end edges 72a, 72b of each slot 72 on the perimeter of the respective slot 72, and a radially outer peak edge 72f of the perimeter between end edge 72b and middle edge 72e are further away from center axis 11 than radially outer middle edge 72e. For slot 74, a radially inner middle edge 74c of slot 74 halfway between circumferential edges 74a, 74b of each slot 74 is not the point of the perimeter of slot 74 that is closest to center axis 11, with a radially inner peak edge 74d of the perimeter between end edge 74a and middle edge 74c being closer to center axis 11 than middle edge 74c and a radially inner peak edge 74e of the perimeter between end edge 74b and middle edge 74c being closer to center axis 11 than middle edge 74c.

As also shown in FIG. 3a, in which masses 62 have traveled zero degrees with respect to flange 60, slots 74 are radially and circumferentially larger than slots 72 and slots 72 are approximately circumferentially centered within slots 74 such that both of the circumferential end edges 72a, 72b of each slot 72 are spaced from the respective circumferential end edge 74a, 74b of the respective slot 74 that the two slots 72—one in each mass element 62a, 62b—are aligned with. Additionally, slots 72 are each radially aligned in the respective slot 74 such that radially outer peak edges 72d, 72f are closer to the perimeter of slot 74 than radially inner peak edge 72c. In the embodiment shown in FIG. 3a, radially outer peak edge 72f is coincident with the perimeter of slot 74.

As shown in FIG. 3a, masses 62 are tuned such that a center 82 (FIG. 3a) of the pendulum mass 62 swings in a pendulum motion along a path 76 having a varying curvature during operation of CPA 32. In FIG. 3a, center 82 of mass 62 is at a center of the path—i.e., mass 62 is not displaced along the path 76. In other words, center 82 swings in a pendulum motion about a center point 84 during the rotation of CPA about axis 11 (FIG. 2), such that center 82 is at different distances 86a, 86b from center point 84 during path 76. Masses 62 are tuned to a higher order at the ends 76a, 76b of their travel paths 76 to bring masses 62 radially inward, which brings masses 62 closer together. More specifically, FIG. 3a shows a middle region 76c of path 76, which is circumferentially between ends 76a, 76b of path 76, having a constant curvature, which may vary slightly due to manufacturing tolerances, then ends 76a, 76b each turn radially inward from the middle region 76c, while at the same time continuing to extend circumferentially. Ends 76a, 76b each extend radially inward toward center point 84 and center axis 11 (FIG. 2) such that ends 76a, 76b have a different curvature than middle region 76c, with the curvature of ends 76a, 76b having a smaller effective radius that the curvature of middle region 76c. Accordingly, path 76 that a center of mass 62 follows during the operation of CPA 32 has a constant curvature with respect to center axis 11 until the mass 62 reaches either of ends 76a, 76a, upon which mass 62 moves radially inward toward center axis 11. End edges 76d of path 76 are a distance 86b from center point 84 that is less than distance 86a from a center of path 76 to center point 84. During operation, mass 62 travels at in both circumferential directions at an angle ϕ with respect to the center of path 76 having a maximum value at end edges 76d.

The movement of masses 62 radially inward toward center axis 11 causes a first circumferential end 68 of each mass set to move closer to a second circumferential end 69 of each mass set, thereby compressing springs 64. FIG. 3a also illustrates possible paths 80b, 80c taken by centers 61a of rollers 61. A spacer or bolt 63 (FIGS. 3b, 3c) that fixes mass elements 62a, 62b together, follows a path 77 in track 75 having a different curvature at the circumferential ends 77a, 77b thereof than in the middle region 77c thereof.

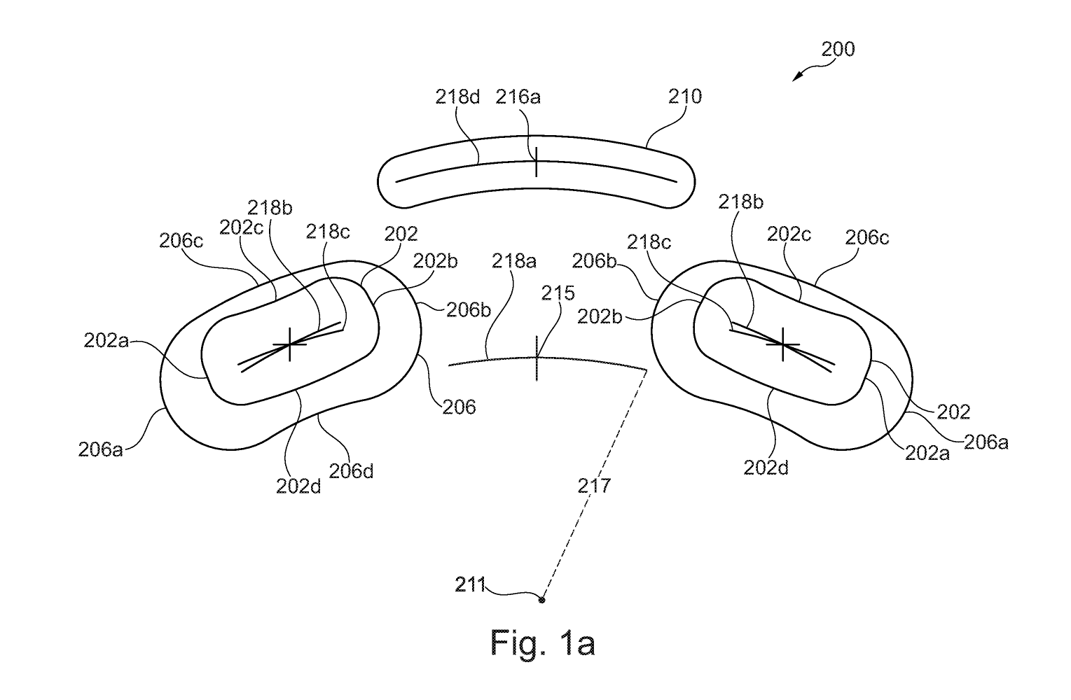

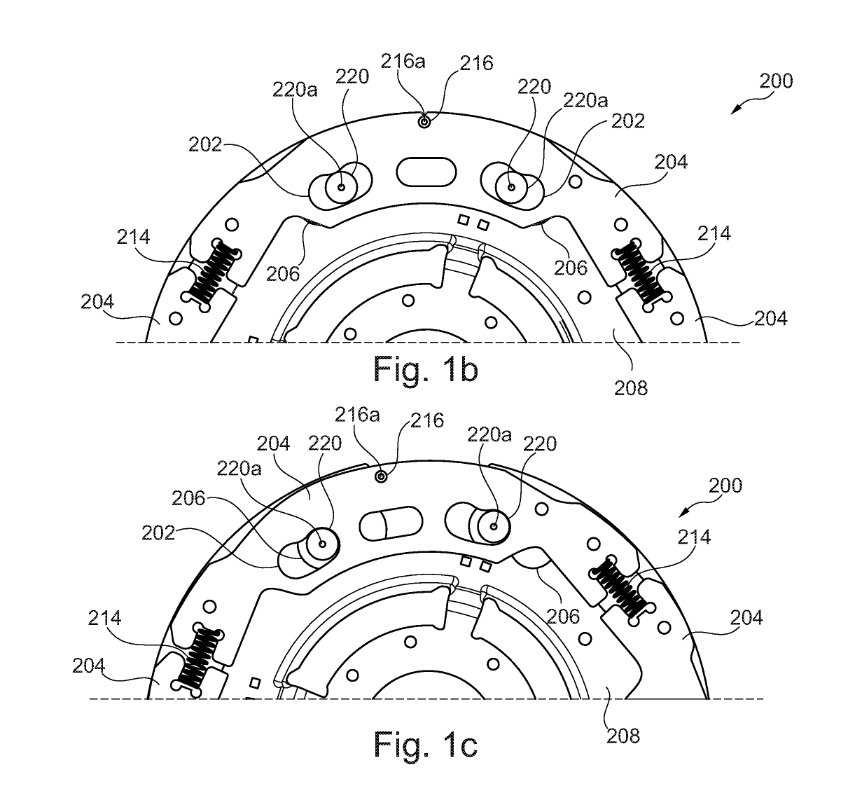

Referring to FIGS. 3b, 3c, springs 64 are of a lower rate than conventional springs 214 described above with respect to FIGS. 1a to 1c. This is possible due to the inward movement of masses 62 at ends 76a, 76b of path 76. The greater compression of springs 64 than with springs 214 of CPA 200 stores more energy, allowing the lower spring rate. Each spring 64 includes a first circumferential end 64a held in the first circumferential end 68 of one mass set and a second circumferential end 64b held in the second circumferential end 69 of another mass set.

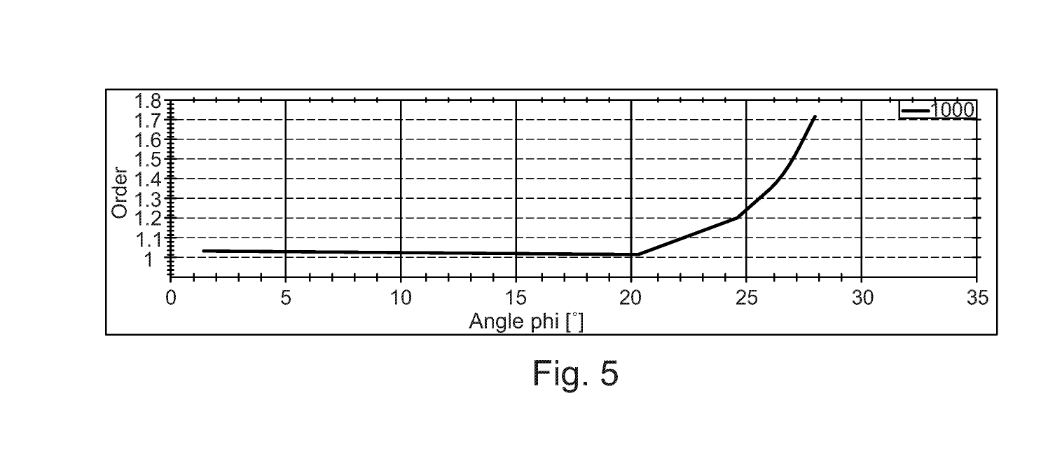

FIG. 5 shows a graph illustrating the tuning order of CPA masses in accordance with an exemplary embodiment of the present disclosure. The graph illustrates the tuning order versus the angle ϕ of travel of the CPA masses and will be described in combination with FIGS. 3a to 3c. The example in FIG. 4 relates to a two-cylinder engine. As shown in FIG. 4, the CPA masses each have a tuning order of approximately 1.02 (with a tolerance of 5%) up to approximately 20.5 degrees of travel. This tuning is typical of what would be considered ideal tuning four a four-stroke engine—i.e., the ideal tuning is half of the number of cylinders in a four stroke engine, with a tolerance of about 5% for manufacturing deviations, oil influence, etc. At approximately 20.5 degrees of travel, the tuning continuously increases. For example, with respect to FIG. 3a, this increase begins when the curvature of path 76 changes at either of ends 76a, 76b. The tuning order increases exponentially until the maximum travel is reached—i.e., at end edges 76d in FIG. 3a, 28 degrees in FIG. 5. Accordingly, the maximum tuning order reached is 1.7, which is 70% greater than the ideal tuning order for the engine in which the CPA is configured to be used. In preferred embodiments, the maximum tuning order of the masses of the present disclosure is at least approximately 50% greater than the ideal tuning order (i.e., 50% greater with a tolerance of 10%).

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

### LIST OF REFERENCE NUMERALS

10 torque converter

11 center axis

12 front cover

14 rear cover

16 impeller shell

18 impeller

20 turbine

22 stator

24 turbine blades

26 rounded blade receiving portion

28 inner radial extension

30 damper assembly

32 centrifugal pendulum absorber (CPA)

34 first cover plate

36 second cover plate

38 radially inner springs

40 drive flange

42 radially outer springs

44 radially outer end of second cover plate

46 spring retainer

50 piston

52 clutch plate

54 projections

56a friction material

56b friction material

58 inner axial surface

60 flange

61 rollers

61a roller center

62 masses

62a rear side mass elements

62b front side mass elements

63 spacer or bolt

64 springs

72 mass roller-receiving slots

72a circumferential end edge

72b circumferential end edge

72c radially inner middle peak edge

72d radially outer peak edge

72e radially outer middle edge

72f radially outer peak edge

74 flange roller-receiving slots

74a circumferential end edge

74b circumferential end edge

74c radially inner middle edge

74d radially inner peak edge

74e radially inner peak edge

75 track

76 pendulum motion path

76a end of pendulum motion path

76b end of pendulum motion path

76c middle region of pendulum motion path

77 spacer or bolt path

77a circumferential end of spacer or bolt path

77b circumferential end of spacer or bolt path

77c middle region of spacer or bolt path

79a radially outer slots

79b radially inner slots

82 mass center

84 pendulum motion center point

86a distance between mass center and pendulum motion center point

86b distance between mass center and pendulum motion center point

200 centrifugal pendulum absorber (CPA)

202 mass roller-receiving slots

202a circumferential edge

202b circumferential edge

202c outer edge

202d inner edge

204 mass

206 flange roller-receiving slots

206a circumferential edge

206b circumferential edge

206c outer edge

206d inner edge

208 flange

210 track

211 pendulum motion center point

214 springs

215 pendulum mass center

216 spacer or bolt

218a pendulum motion path

218b pendulum motion path

218c pendulum motion path

218d pendulum motion path

1: A centrifugal pendulum absorber comprising:
a flange;
a first mass fixed circumferentially movable with respect to the flange by a first roller along a first pendulum path;
a second mass fixed circumferentially movable with respect to the flange by a second roller along a second pendulum path; and
a spring connecting a circumferential end of the first mass to a circumferential end of the second mass, the first and second pendulum paths each including a middle region and circumferential ends extending radially inward from the middle region such that the first and second masses are movable radially inward such that the spring compresses when first and second masses are at the circumferential ends of the respective first and second pendulum paths, the circumferential ends of the first and second pendulum paths each having a higher tuning order than the middle regions.

2: The centrifugal pendulum absorber as recited in claim 1 wherein the flange includes a first flange slot receiving the first roller and a second flange slot receiving the second roller, the first mass includes a first mass slot receiving the first roller and the second mass includes a second mass slot receiving the second roller.

3: The centrifugal pendulum absorber as recited in claim 2 wherein each of the first mass slots and the second mass slots have a convex shape with respect to a center axis of the centrifugal pendulum absorber and the first flange slot and the second flange slot have a concave shape with respect to center axis.

4: The centrifugal pendulum absorber as recited in claim 3 wherein in a position of zero degrees of travel of the first and second masses with respect to the flange, the first mass slots are aligned within the first flange slot and the second mass slots are aligned within the second flange slot.

5: The centrifugal pendulum absorber as recited in claim 4 wherein in the position of zero degrees of travel of the first and second masses with respect to the flange, radially outer peak edges of each of the first mass slots are closer to a perimeter of the first flange slot than a radially inner peak edge of the respective first mass slot and radially outer peak edges of each of the second mass slots are closer to a perimeter of the second flange slot than a radially inner peak edge of the respective second mass slot.

6: The centrifugal pendulum absorber as recited in claim 1 wherein the middle regions of the first and second pendulum paths each have a constant curvature.

7: The centrifugal pendulum absorber as recited in claim 6 wherein the circumferential ends of the first and second pendulum paths each have a curvature different from the constant curvature of the middle regions.

8. (canceled)

9: The centrifugal pendulum absorber as recited in claim 1 wherein circumferential ends of the first and second pendulum paths each have at least a 50% higher tuning order than the middle regions.

10: The centrifugal pendulum absorber as recited in claim 9 wherein the middle regions have a tuning order within 5% of an ideal tuning order.

11: A torque converter comprising:
a damper assembly including the centrifugal pendulum absorber as recited in claim 1.

12: A method of forming a centrifugal pendulum absorber comprising:
circumferentially movably fixing a first mass to a flange such that the first mass is configured for traveling along a first pendulum path;
circumferentially movably fixing a second mass to the flange such that the second mass is configured for traveling along a second pendulum path; and
connecting a circumferential end of the first mass to a circumferential end of the second mass by a spring, the first mass and the second mass being movable radially inward such that the spring compresses when first and second masses are at circumferential ends of the respective first and second pendulum paths, middle regions of the first and second pendulum paths each having a constant curvature, the circumferential ends of the first and second pendulum paths each having a curvature different from the constant curvature of the middle regions.

13: The method as recited in claim 12 further comprising providing a first roller in a first flange slot of the flange and in a first mass slot in each of the first masses; and providing a second roller in a second flange slot of the flange and in a second mass slot in the second mass.

14: The method as recited in claim 13 wherein each of the first mass slots and the second mass slots have a convex shape with respect to a center axis of the centrifugal pendulum absorber and the first flange slot and the second flange slot have a concave shape with respect to center axis.

15: The method as recited in claim 13 wherein in a position of zero degrees of travel of the first and second masses with respect to the flange, the first mass slots are aligned within the first flange slot and the second mass slots are aligned within the second flange slot.

16. (canceled)

17. (canceled)

18: The method as recited in claim 12 wherein circumferential ends of the first and second pendulum paths each have higher tuning order than the middle regions.

19: The method as recited in claim 18 wherein circumferential ends of the first and second pendulum paths each have at least a 50% higher tuning order than the middle regions.

20: The method as recited in claim 19 wherein the middle regions have a tuning order within 5% of an ideal tuning order.

21: A centrifugal pendulum absorber comprising:
a flange;
a first mass fixed circumferentially movable with respect to the flange by a first roller along a first pendulum path;
a second mass fixed circumferentially movable with respect to the flange by a second roller along a second pendulum path; and
a spring connecting a circumferential end of the first mass to a circumferential end of the second mass, the first and second pendulum paths each including a middle region and circumferential ends extending radially inward from the middle region such that the first and second masses are movable radially inward such that the spring compresses when first and second masses are at the circumferential ends of the respective first and second pendulum paths, the middle regions of the first and second pendulum paths each having a constant curvature, the circumferential ends of the first and second pendulum paths each having a curvature different from the constant curvature of the middle regions.
